(19) United States
(12) Patent Application Publication
(10) Pub. No.: US 2025/0277554 A1
(43) Pub. Date: Sep. 4, 2025

(54) LOW-VIBRATION CRYOGEN DELIVERY SYSTEM AND METHOD

(71) Applicant: Lake Shore Cryotronics, Inc., Westerville, OH (US)

(72) Inventors: Thomas Bapu, Lewis Center, OH (US); Eric King, Dublin, OH (US); Robert William Scites, IV, Columbus, OH (US)

(21) Appl. No.: 19/068,168

(22) Filed: Mar. 3, 2025

Related U.S. Application Data
(60) Provisional application No. 63/560,620, filed on Mar. 1, 2024.

(51) Int. Cl. F16L 55/04; B33Y 80/00; G01N 1/42

(52) U.S. Cl. CPC F16L 55/041; G01N 1/42; B33Y 80/00

(57) ABSTRACT

A cooling system. The system includes a conduit configured to carry a cryogenic fluid to a cooling target and a support supporting the conduit. The support includes a first clamp for clamping the conduit in place and a first weight for dampening vibrations in the conduit, wherein the support dampens nm-scale vibrations.

### CROSS-REFERENCE TO RELATED APPLICATION

This application claims the benefit of U.S. Provisional Patent Application Ser. No. 63/560,620, filed Mar. 1, 2024 and entitled “LOW-VIBRATION CRYOGEN DELIVERY SYSTEM AND METHOD,” the priority of which is hereby claimed and the disclosure of which is incorporated herein by reference in its entirety.

### FIELD OF DISCLOSURE

The subject disclosure relates to cooling systems that may be used for various purposes, including for cooling material samples to measure properties (e.g., electronic, optical, physical, etc.). The subject disclosure also relates to systems that perform vibration-sensitive measurements, particularly those that obtain measurements from a sample under cooled or cryogenic conditions.

### BACKGROUND

Materials properties measured under cryogenic conditions are useful in a number of fields, such as semiconductor materials and device testing. Reasons for performing measurements under these conditions are many. For example, extremely low temperatures may be necessary for certain important device or materials properties to manifest in ways that are measurable by analytical equipment. Low temperatures can also reduce or remove stray vibrations or signals that can interfere with measurements of those properties.

More generally, cryogenic temperatures mean lower thermal noise, lower thermal energy, and reduced random motion of charge carriers. This can improve precision and observation of electronic properties, particularly in superconductive materials. For similar reasons, it can allow measurements of semiconductor properties (e.g., bandgaps) with a high level of precision. At cryogenic temperatures, quantum effects become more prominent and can be studied more readily. This facilitates study of quantum dots, quantum wells, and other nanoscale semiconductor structures. Some semiconductor experiments involve the interaction of semiconductors with other materials or external fields that can be more precisely controlled and studied at cryogenic temperatures. Still other measurements, such as radiation detection, improve under cryogenic conditions. For at least the reasons described above, cryogenic conditions can provide a more stable environment for a variety of applications. All of these and other related applications, whether expressly mentioned herein or not, are to be considered within the scope of the present disclosure.

Unfortunately, the logistics of cooling samples to cryogenic temperatures can introduce vibrations large enough to confound the very measurements the cooling is meant to facilitate. This is at least in part because most cryogenic systems cool by physically circulating a cooling liquid (cryogen) throughout the measurement (and related) systems. Fluid flow through pipes during cryogen delivery and circulation can vibrate components mechanically coupled to the pipes. Active components needed to drive the fluid through the pipes (e.g., compressors) also introduce potentially problematic vibrations. Similar issues may be caused by circulation of suitable cryogenic liquid (e.g., liquid helium (He), liquid nitrogen (N₂), liquid hydrogen (H₂), liquid oxygen (LOX), liquid argon (Ar), liquid neon (Ne), carbon monoxide (CO), carbon dioxide (CO₂), and liquid xenon (Xe)).

These problems become even more acute when the cryogenic fluid is recycled instead of discarded after being used to cool the sample. Traditional systems simply dispose of spent cryogen (e.g., by flushing it out of the system). In that case, disposal can require little flow of spent cryogen through the measurement system. Less flow means less opportunity to cause vibrations. For the opposite reason, systems that recycle cryogen (e.g., liquid He) compound and exacerbate vibrational issues. This is because recycling requires circulating spent or used cryogen back to the cooling system from the sample to re-cool the cryogen. In this way, recycling increases, and may even double, cryogen flow through the measurement system. This necessarily increases vibrations. Moreover, additional use of pumps and conduits may be needed to send the spent cryogen back to the compressor. In some cases, new active components may even need to be added. All this introduces more vibration sources to the system. In fact, any additional circulation of cryogen in the system for any reason, whether related to recycling or not, can potentially introduce vibrations that may interfere with the measurements.

Moreover, even very small vibrations on the scale of nm can be problematic with regard to the materials measurements described above. Most vibration dampening techniques are effective at damping only larger scale vibrations that are at least tens of nm in amplitude. However, some measurements require information extraction from atomic scale features that would be “washed out” by much smaller-scale, even nm-scale, vibrations. Others will be rendered ambiguous by those same vibrations. Therefore, there is a need to develop a system that can dampen vibrations on very small size scales having very small vibrational amplitudes (e.g., nm).

### SUMMARY

Disclosed herein is a cooling system. The system includes a conduit configured to carry a cryogenic fluid to a cooling target and a support supporting the conduit. The support includes a first clamp for clamping the conduit in place and a first weight for dampening vibrations in the conduit, wherein the support dampens nm-scale vibrations.

The system may be configured to decrease the amplitude of nm-scale vibrations induced by the coolant supply by greater than 99% before reaching the sample. The system may be configured to decrease an amplitude of nm-scale vibrations induced by a pump by greater than 80% before reaching a sample. The system may be configured to decrease the amplitude of nm-scale vibrations induced by the pump by greater than 92% before reaching the sample.

The support may include a second clamp for clamping the conduit in place and a second weight for dampening vibrations in the conduit. The first weight may be vibrationally isolated from the second weight. The first weight may be vibrationally isolated from a floor on which the cooling system rests. The first weight may be vibrationally connected to a floor on which the cooling system rests. The second weight may be vibrationally isolated from a floor on which the cooling system rests.

The system may include a sub-system for recycling the cryogenic fluid. The sub-system may include a vacuum pump and a line to the vacuum pump. The line to the vacuum pump may be coupled to a mass to dampen vibrations. The mass may be vibrationally de-coupled from the first weight. The mass may be vibrationally de-coupled from any other weights in the cooling system. The line to the vacuum pump may be coupled to a vibration-dampening table via a third clamp. The third clamp may be molded to the lines bellows.

At least one of the first clamp and the second clamp may be 3D printed. An inner surface of the at least one clamp may conform to an outer surface of a bellows. The bellows may be on the conduit.

Also disclosed herein is a measurement system including the cooling system. The measurement system may include a sample, wherein the sample is vibrationally isolated from the cooling system. The measurement system may include an analytical device for performing at least one of Energy Dispersive X-ray Spectroscopy (EDS or EDX), X-ray Fluorescence Spectroscopy (XRF), X-ray Photoelectron Spectroscopy (XPS or ESCA), Extended X-ray Absorption Fine Structure (EXAFS), X-ray Absorption Near Edge Structure (XANES), X-ray Emission Spectroscopy (XES), and X-ray Diffraction (XRD). The measurement system may include an analytical device for performing at least one of Auger Electron Spectroscopy (AES), Photoemission Spectroscopy (PES), Inverse Photoelectron Spectroscopy (IPES), Angle-Resolved Photoemission Spectroscopy (ARPES), X-ray Photoelectron Spectroscopy (XPS or ESCA), Electron Energy Loss Spectroscopy (EELS), and Cathodoluminescence Spectroscopy (CL).

The cooling system may include at least one of a coolant supply and a pump, wherein the at least one of a coolant supply and a pump comprises support feet. The support feet may have at least one of a pad, matt, and a coating. The at least one of a pad, matt, and a coating may include at least one of rubber, foam, and tape.

Also disclosed herein is a method of cooling a sample for testing using a cooling system. The method includes supplying a cryogenic fluid to a cooling target via a conduit, dampening nm-scale vibration in the cooling system via a support supporting the conduit. The support includes a first clamp for clamping the conduit in place and a first weight for dampening vibrations in the conduit.

The dampening nm-scale vibration in the cooling system may decrease an amplitude of nm-scale vibrations induced by a coolant supply by greater than 90% before reaching a sample. The dampening nm-scale vibration in the cooling system may decrease the amplitude of nm-scale vibrations induced by the coolant supply by greater than 99% before reaching the sample. The dampening nm-scale vibration may decrease an amplitude of nm-scale vibrations induced by a pump by greater than 80% before reaching a sample. The dampening nm-scale vibration in the cooling system may decrease the amplitude of nm-scale vibrations induced by the pump by greater than 92% before reaching the sample.

The support may include a second clamp for clamping the conduit in place and a second weight for dampening vibrations in the conduit. The testing may include at least one of Energy Dispersive X-ray Spectroscopy (EDS or EDX), X-ray Fluorescence Spectroscopy (XRF), X-ray Photoelectron Spectroscopy (XPS or ESCA), Extended X-ray Absorption Fine Structure (EXAFS), X-ray Absorption Near Edge Structure (XANES), X-ray Emission Spectroscopy (XES), and X-ray Diffraction (XRD). The testing may include at least one of Auger Electron Spectroscopy (AES), Photoemission Spectroscopy (PES), Inverse Photoelectron Spectroscopy (IPES), Angle-Resolved Photoemission Spectroscopy (ARPES), X-ray Photoelectron Spectroscopy (XPS or ESCA), Electron Energy Loss Spectroscopy (EELS), and Cathodoluminescence Spectroscopy (CL).

### BRIEF DESCRIPTION OF DRAWINGS

FIG. 1 shows an exemplary setup 100 where vibrations can be problematic.

FIG. 2 shows an alternative embodiment system 200 to setup 100, according to aspects of the present disclosure.

FIG. 3 shows an alternative embodiment system 300, according to aspects of the present disclosure.

FIG. 4 shows an alternative embodiment system 400, according to aspects of the present disclosure.

FIG. 5A shows an exemplary design for a vibration dampening foot.

FIG. 5B shows another exemplary design for a vibration dampening foot.

FIG. 6A shows an exemplary bellows design for a cooling line.

FIG. 6B is a cross-sectional drawing that illustrates of how the molded clamp fits with line B1 bellows.

FIG. 6C is a cross-sectional drawing that illustrates details of molded clamps mating structure designed to fit with line B1 bellows.

FIG. 6D is a drawing that illustrates how the molded clamp can be used in conjunction with a vibrational damping table.

FIG. 6E is a drawing that illustrates how the molded clamp can mount a cooling line to the table of FIG. 6D.

FIG. 7A shows an experimental setup 700 for testing vibration mediating designs, including those disclosed herein.

FIG. 7B shows an alternative mass dampener 735.

FIG. 7C shows another view of mass dampener 735.

FIG. 7D shows another view of mass dampener 735.

FIG. 8 is a schematic showing the essential components of setup 700 for data acquisition.

FIG. 9 shows the results of the vibration RMS measurement by component for system 700.

FIG. 10 is a schematic showing a cryostat and various directions for vibrational testing.

FIG. 11 shows the laser position in the experimental setup 700 for x or y direction vibrational measurements.

### DETAILED DESCRIPTION

Several illustrative embodiments will be described in detail with the understanding that the present disclosure merely exemplifies the general inventive concepts. Embodiments encompassing the general inventive concepts may take various forms and the general inventive concepts are not intended to be limited to the specific embodiments described herein.

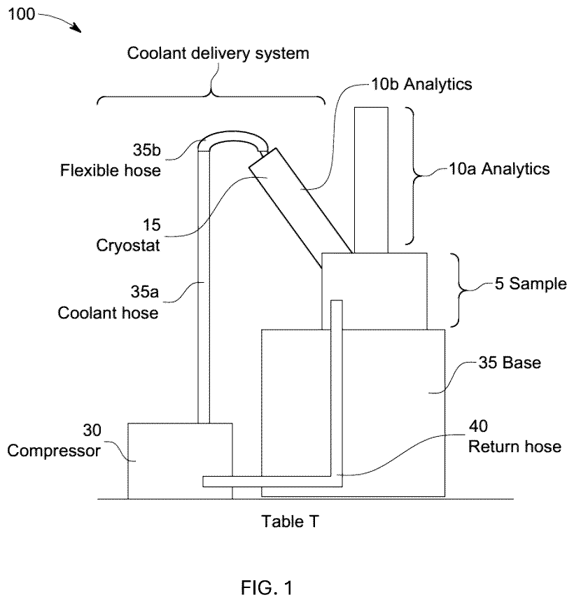

FIG. 1 shows an exemplary setup 100 where vibrations of the kind discussed above can be problematic. Measurement system 100 includes at least one material sample for taking cryogenic measurements. Sample 5 identified in FIG. 1 is a chamber or component of measurement system 100 that houses the actual material sample (not shown). That said, herein, the sample and its chamber will be referred to collective as “the sample 5.”

System 100 further includes analytics 10a and 10b. They are mounted proximally to sample 5 so that they may obtain measurements. Analytics 10a and 10b may include any known measurement, including measurements expressly mentioned herein and those that are not expressly mentioned. Examples include scanning electron microscopy, X-ray spectroscopy, and other analytical techniques (e.g., Energy Dispersive X-ray Spectroscopy (EDS or EDX), X-ray Fluorescence Spectroscopy (XRF), X-ray Photoelectron Spectroscopy (XPS or ESCA), Extended X-ray Absorption Fine Structure (EXAFS), X-ray Absorption Near Edge Structure (XANES), X-ray Emission Spectroscopy (XES), X-ray Diffraction (XRD), Auger Electron Spectroscopy (AES), Photoemission Spectroscopy (PES), Inverse Photoelectron Spectroscopy (IPES), Angle-Resolved Photoemission Spectroscopy (ARPES), X-ray Photoelectron Spectroscopy (XPS or ESCA), Electron Energy Loss Spectroscopy (EELS), and Cathodoluminescence Spectroscopy (CL)).

In addition, FIG. 1 shows a cryostat 15 included in system 100 that may manage delivery of coolant and/or cooling to sample 5 and analytics 10a and 10b. Cryostat 15 can maintain low temperatures for scientific experiments, materials research, superconductivity studies, and medical and other applications. Cryostat 15 can include an insulated chamber, temperature control mechanisms, and other components to manage and monitor the cryogenic environment.

Although FIG. 1 shows cryostat 15 and other components of the Coolant Delivery System as a focus of the disclosure, it is to be understood that applications of concepts disclosed herein may go beyond system 100. The concepts may more generally apply to systems that do not actually include cryostats. For example, vibration mitigation (and other) solutions disclosed herein may be applied to probe stations, experiment inserts, optical stations, and/or electromagnets.

FIG. 1 further shows the Coolant Delivery System including a compressor 30 that may work in conjunction with cryostat 15. Compressor 30 is primarily a circulation pump that could include a compressor and/or a vacuum pump. Compressor 30 can be any component that circulates and/or manages flow of the cryogenic fluid or refrigerant within system 100. Compressor 30 may distribute cryogen within system 100 in conjunction with other components, such as pipes, valves, an expansion device (not shown), etc. For example, compressor 30 may provide coolant (e.g., liquid He) through hose 35a and flexible hose 35b to cryostat 15. Doing so may maintain the required pressure and temperature conditions of the cryogenic fluid for a refrigeration cycle sufficient to cool sample 5.

FIG. 1 also shows that system 100 further includes return hose 40. Return hose 40 removes spent coolant from cryostat 15 for recycling (e.g., re-pressurization and redistribution to cryostat 15 via hoses 35a and 35b) through the Coolant Delivery System. As discussed in more detail below, the systems and methods disclosed herein can obtain and maintain measurement accuracy while recycling cryogen, such as liquid He. Recycling cryogen is increasingly common, frequently driven by cost and environmental considerations.

It is to be understood that the Coolant Delivery System shown in FIG. 1, and system 100 more generally, is merely exemplary. It is meant to illustrate certain principles described herein without being limiting. Significant changes may be made to system 100 and still be within the scope of the present disclosure. For example, the Coolant Delivery System may include more hoses 35a and 35b, valves, and/or other conduits beyond those shown (implied or suggested) in FIG. 1 or other figures herein. In another example, not all systems 100 necessarily include return hose 40 or the capability to recycle cryogen. It is to be understood that still other variations are possible and within the scope of the present disclosure.

As shown in FIG. 1, the above-mentioned components (e.g., sample 5, analytics 10a and 10b, and cryostat 15, for example) may be mounted on a common base 35 that is fixed to a Table T. Although not expressly shown in FIG. 1, Table T (as well as any other table described or suggested herein) may be a “floating” pneumatic table for dampening vibrations. This is a table that incorporates pneumatic elements for height adjustment. For example, Table T may be a laboratory-type (or other) air table that uses pneumatics (compressed air) to generate mechanical motion of its top surface (not shown). In that context, Table T can allow the top surface to stay fairly level despite vibrations produced by system 100 (e.g., by the Coolant Delivery System). In this way, Table T can also dampen vibrations in system 100 to, for example, improve measurement quality as described above.

Other types of Tables T that may be used with system 100 or the other systems described herein include mechanically adjustable tables. These are tables with mechanical height-adjustment mechanisms that may use automatic (e.g., computer-driven) systems and/or hand cranks or gears to change the table height. Others use electric motors to adjust the height. Still other options include hydraulicly adjustable tables. These are similar to pneumatic tables but use fluid (usually oil) to enable height adjustments. All of these table types may be used to dampen vibrations in system 100 to some degree. In addition, fixed-height tables and mobile workstations (e.g., tables on wheels) may also be used. Table T may be fitted with a vibration and/or noise-dampening system that is separate and apart from its internal construction. Table T may also rest on a vibration and/or noise-dampening system or platform. Any suitable vibration and/or noise-dampening system may be used for this purpose, including any described, suggested, or implied herein.

Multiple noise and vibration mitigation measures can be employed simultaneously in system 100. For example, Table T may dampen vibrations from the sample 5 side of system 100. Vibrations from the Coolant Delivery System side of system 100 may also be dampened similarly by Table T or another vibration-dampening device (not shown). Yet even with Table T and other noise/vibration dampening systems, excessive vibrations can still confound measurements taken by system 100. For example, the multiple dampening systems described above (and more generally) may not prevent vibrations from the Coolant Delivery System from being transmitted to the sample via hoses 35a, 35b, and 40. In fact, system 100 as shown in FIG. 1 has no way to dampen such vibrations before they reach sample 5. Some vibrations (e.g., those caused by the Coolant Delivery System, and specifically compressor 15) may have extremely small amplitude (e.g., 5 nm amplitude or even 1 nm amplitude). Such small vibrations may not be effectively mitigated by Table T or the other conventional systems.

Therefore, there is a need to dampen vibrations from the Coolant Delivery System before they can be transmitted to sample 5. This need is heightened by additional vibrations caused by recycling cryogen in a closed-loop system (i.e., via hose 40, as described above). As one example, it may be advantageous for vibrations/noise in the Coolant Delivery System to be decreased independently (i.e., in vibrational isolation) of vibration dampening in other parts of system 100, etc.

Several solutions to the above-described problems are presented herein. Each solution and its related aspects may be applied separately or together in combinations. Moreover, it is to be understood that each of the solutions described below and more generally herein may be applied to system 100 of FIG. 1. This is true even if system 100 has not been redrawn in this disclosure to expressly include features or components that are described as part of the solution. More generally, it is to be understood that the discussion that follows may be directly applied to system 100 and suitable variations, whether described above or not.

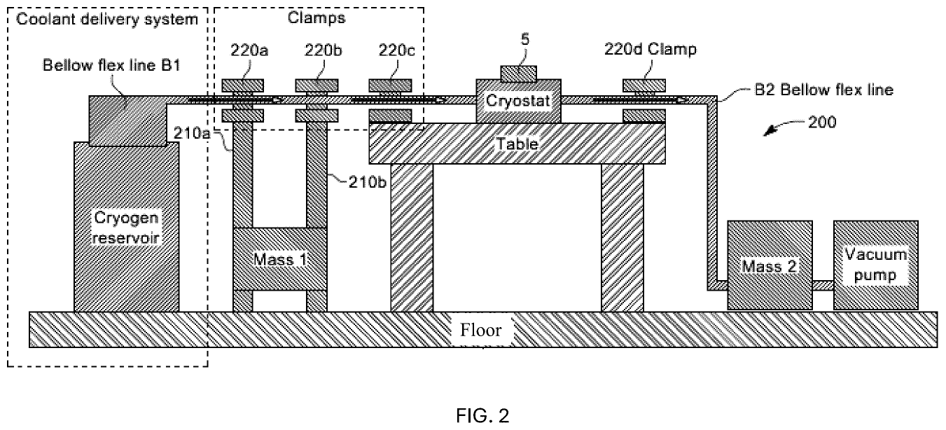

One exemplary solution to the problem of vibrations being transmitted from the Coolant Delivery System to sample 5 involves multiple mass dampeners and connection points beyond those shown in FIG. 1. This alternative embodiment system 200 is shown in FIG. 2.

It is to be understood that embodiment 200 may also be applicable to system 100 above. Toward that end, components in embodiment 200 (and in other embodiments described herein, such as variations 300 and 400) that have the same names or designations of components in system 100 may take on the same form. They may take on any form discussed in the context of system 100 above. For example, the cryostat in embodiment 200 may correspond to cryostat 15, the table may correspond to Table T, and the bellow flex line B1 may correspond to flexible hose 35b and/or hose 35a. It is to be understood that sample 5 in embodiment 200 may be located in part of the cryostat.

One difference between system 100 and system 200 is that system 200 rests fewer components on Table T. In fact, Table T dampens only vibrations from the cryostat and/or sample portion of system 200, not its Coolant Delivery System portion. For example, the vacuum pump of system 200's recycling system is resting on the Ground, rather than on Table T. This allows vacuum pump to be vibrationally isolated from cryostat 15, sample 5, and other components. Cryogen reservoir and compressor can also be vibrationally isolated for the same reasons. Therefore, although fewer components in system 200 benefit from Table T's noise dampening, this allows vibrations generated by these (active) components to be vibrationally isolated from sample 5.

Although certain components are shown in FIG. 2 as being supported directly by the ground (e.g., the cryogen reservoir and compressor), it is to be understood that this is merely exemplary. These same components may be supported by another table (e.g., a different but similar vibration-dampening table as Table T of FIG. 1) to, for example, dampen vibrations. However, in system 200, for the reasons discussed above, these components are not supported by the same table that supports the cryostat and sample 5.

Another difference is that system 200 includes an additional bellow flex line B2 to the right of the table that may, for example, correspond to return hose 40 in FIG. 1. Line B2 is part of the recycling system, i.e., the system that processes “spent” or used coolant pumped by the compressor of system 200 (located near the cryogen reservoir, though not shown in FIG. 2).

System 200 also includes two arm structures 210a and 210b that are attached to a mass. Arms 210a and 210b are fixed to bellow flex line B1 via clamps 220a and 220b, respectively. One purpose of this configuration is to hold line B1 via mass to dampen vibrations imparted to B1 before they reach sample 5. Such vibrations may be imparted to line B1, for example, by the compressor (located near the cryogen reservoir). The vibrations may also be caused by flow of coolant through B1 and other parts of system 200. One cause of vibrations, for example, is cavitation or gas in the coolant flowing through B1. In any event, fixing line B1 to the mass via clamps 220a and 220b dampens vibrations. Because clamps 220a and 220b mechanically couple line B1 to the mass, vibrational energy is dissipated by moving the mass up or down against gravity.

The mass shown in FIG. 2 can have any suitable weight for its vibration-dampening purpose. For example, masses of several g, several kg, tens of kg, and even hundreds of kg may be used. Moreover, any material with these weights may be used. For example, steel blocks may be used. Sand, concrete, iron filings, and ball bearings may be used. In certain variations, liquid containers may be filled with liquid and used as the mass. Although the mass may appear to be a monolithic component in FIG. 2, it is to be understood that this is merely exemplary. The mass could be anything having sufficient weight. For example, the mass could be heavy equipment or devices (e.g., electronic equipment, etc.).

Arms 210a and 210b can take on any suitable structure that will allow the mass to dampen vibrations in line B1. One possibility is for arms 210a and 210b to be pieces of metal (or other material with sufficient structural integrity) that mechanically couple clamps 220a and 220b with the mass or other components (not shown). Another is for arms 210a and 210b themselves to include substantial mass and, therefore, mass-dampening capabilities. In general, it is advantageous for arms 210a and 210b to be made from stiff material to prevent unnecessary vibrations. Many metals are suitable for this purpose including steel and aluminum. Certain plastics may also be useful. In addition, use of materials like aluminum increases the ability to adjust clamp positions and attach more components.

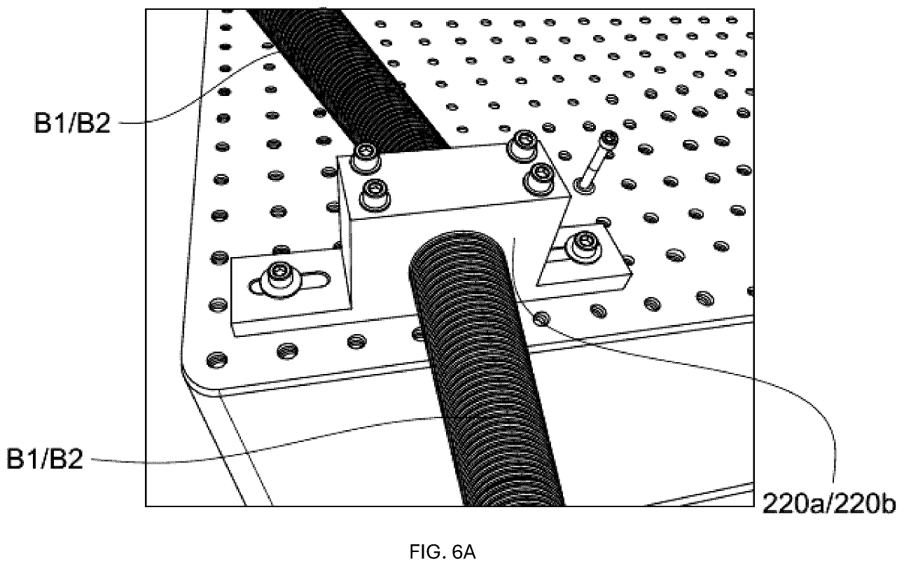

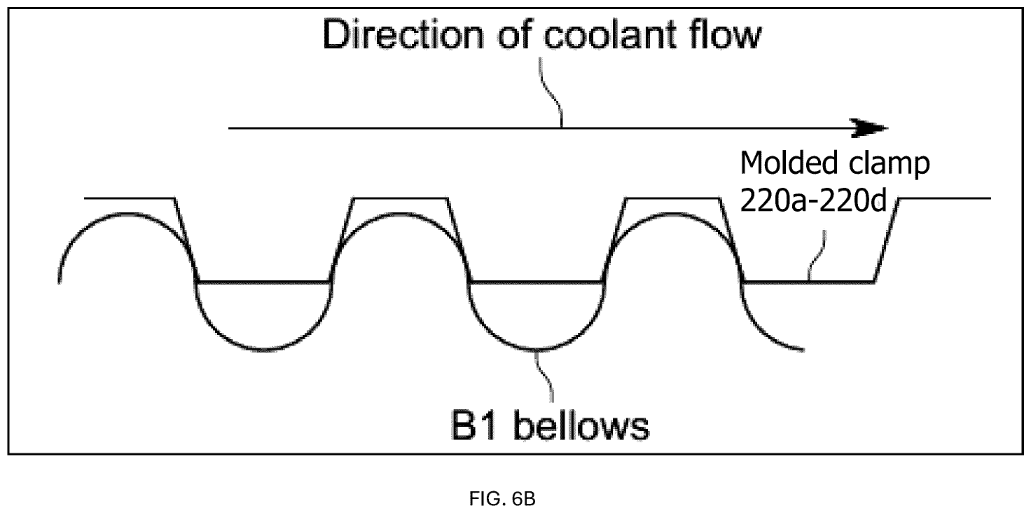

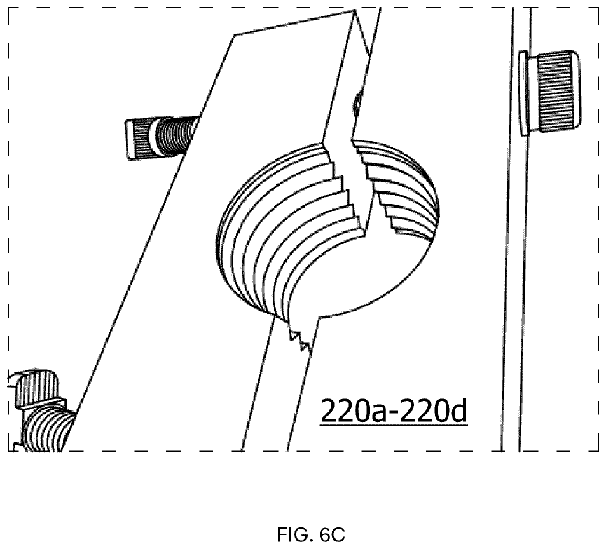

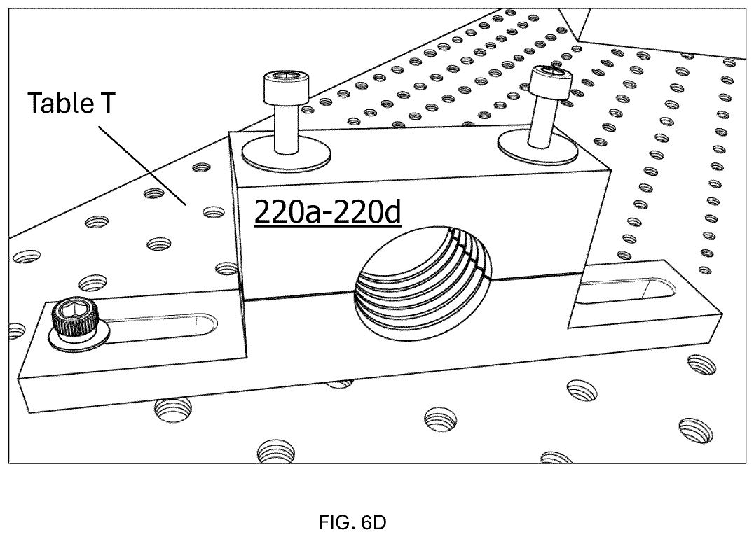

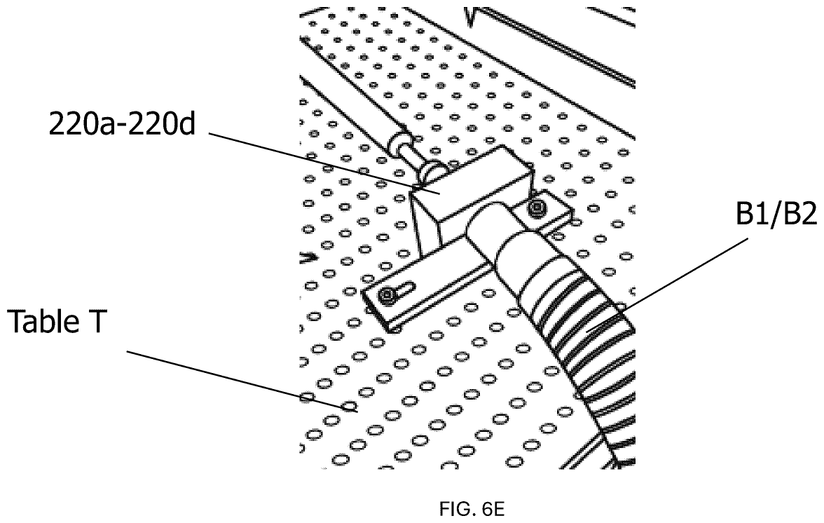

Bellow flex lines B1 and B2 can take on any suitable form. One exemplary form is shown in FIG. 6A below. However, the presentation in FIG. 6A and the corresponding discussion is not meant to be limiting. In other examples, one or more of bellow flex lines B1 and B2 may include regions (or consist entirely) of straight-walled pipe without bellows. In other variations, one or more of lines B1 and B2 may have corrugated metal bellows such that these lines can vibrate in one or more directions. For example, lines B1 and B2 may be configured with bellows (not shown) such that they can vibrate along (or in opposite direction of) the direction of cryogen fluid flow in the line (see, e.g., FIG. 6B). Lines B1 and B2 may also be configured with bellows such that they can flex in a direction perpendicular to this flow. They may be further configured to flex in still more directions.

Clamps 220a and 220b may take on any suitable form, including those discussed in more detail below in the context of FIGS. 6C and 6D. As discussed below, an inventive clamp/hose mating system may help accomplish clamping and increase the efficacy of vibration damping. This is because the tightness with which clamps 220a and 220b hold their respective line B1 and B2 affects their efficacy of vibration damping. Increasing that tightness increases efficacy. On the other hand, loose clamps not only render the mass ineffective at damping line B1's vibrations but may also introduce additional problems, such as additional unwanted vibrations resulting from movement of the loose clamps. For this reason, as described in more detail below, it was found that clamps with ridges matching the form of ridges on line B1 (see, e.g., FIG. 6C) are advantageous in creating a tight clamp. This shape may be formed, for example, via 3D printing (e.g., metal or plastic). In addition, clamps 220a and 220b can be advantageously formed of rigid, non-elastic materials such as steel.

That said, in some embodiments, it may be advantageous for clamps 220a and 220b to substantially clamp the entire periphery of lines B1 or B2 (respectively), as shown in FIG. 2. In this configuration, lines B1 and B2 may be relatively smooth or retain ridges. Interior surfaces of clamps 220a and 220b may be relatively smooth or include ridges, corresponding (or not) to the shape of the lines. It is to be appreciated that many different configurations are possible to give clamps 220a and 220b a tight grip on their respective lines B1 and B2. All should be considered within the context of this disclosure whether expressly represented herein or not.

As shown in FIG. 2, system 200 includes two additional clamps 220c and 220d. These clamps are optionally included, e.g., in cases where system 200 includes a cryogen recycling (or disposal) system. They may be of the same type as clamps 220a and 220b. Clamps 220c and 220d dampen vibrations of their corresponding portions of lines B1 and B2, respectively. In the configuration shown in FIG. 2, the clamps do this by vibrationally coupling these lines to the mass of Table T. In other words, the clamps dampen portions of lines B1 and B2 closest to sample 5 using Table T, the same vibration damping mechanism used to dampen vibrations from sample 5 and cryostat. Alternatively, the clamps may couple the portions of lines B1 and B2 closest to Table T to different masses or vibration-dampening systems (not shown) that may not be part of Table T. In either case, clamps 220c and 220d maintain their respective portions of lines B1 and B2 as somewhat vibrationally independent of the Coolant Delivery System, thus further vibrationally isolating Table T (and components resting thereon) from that system.

FIG. 2 also shows a Mass 2, which is a mass to be used with the “Vacuum pump” that is also shown in the figure. This is an optional mass similar to that fixed to line B1 via arms 210a and 210b. The purpose of Mass 2 is to dampen vibrations occurring on line B2 between clamp 220d and the vacuum pump. Such vibrations may be caused, for example, by the vacuum pump, a cryogenic fluid recycling system, and/or a cryogenic fluid disposal system.

FIG. 2 shows system 200 having two arms 210a and 210b. This is merely exemplary. Any suitable number of arms 210 is possible. However, multiple arms might be advantageous in the sense that each provides a new vibrational node to line B1. Using multiple arms reduces materials and space. Each arm has a consecutive drop in transmission. This is helpful in commonly tight areas like this application.

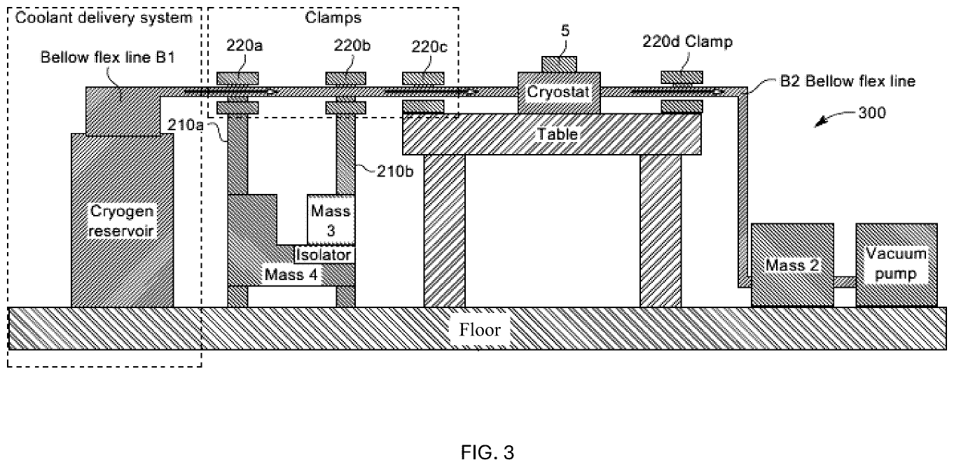

Another exemplary system embodiment 300 is shown in FIG. 3. System 300 is similar to system 200 but also includes of a vibration isolator (“ISOLATOR” in FIG. 3, referred to herein as “isolator”) and an additional mass for arm 210b that is separate and apart from the mass used to dampen arm 210a.

System 300 has all of the advantages of system 200 described above. Additionally, having isolator dampen vibrations from arm 210b close to Table T allows for less vibration (and energy) transfer from line B1 to Table T and the components thereon. This is because arms 210a and 210b are effectively independently damping different portions of line B1. Arm 210a is essentially dedicated to damping vibrations from the compressor/cryogen reservoir side of line B1. At the same time, arm 210b is essentially dedicated to damping vibrations on the side of B1 that is closer to Table T. Therefore, system 300 provides additional protection for sample 5 from vibrations emanating from the compressor. Isolator can be made of elastomeric material and/or a spring-like dampener. One example is rubber. Another is resin.

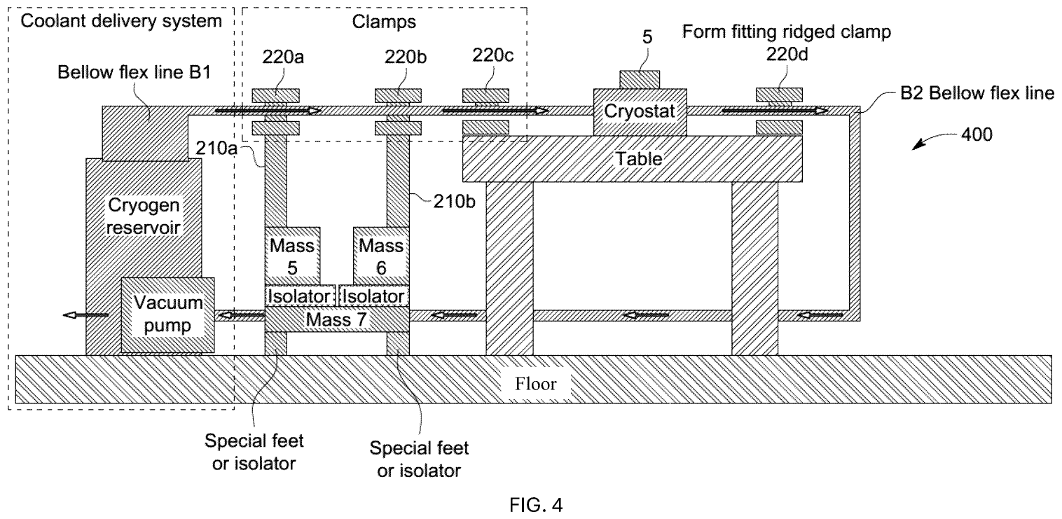

Another exemplary embodiment system 400 is shown in FIG. 4. System 400 is similar to system 300 apart from two modifications. The first is an additional vibration isolator on arm 210a in addition to the isolator for arm 210b. The second modification is that the mass formerly used to dampen arms 210a and 210b in system 200 is now used to dampen vibrations in bellow flex line B2.

System 400 has advantages of systems 200 and 300 described above. Additionally, having isolator dampen vibrations from arm 210a enhances the effect discussed above, namely that both arms 210a and 210b receive separate damping. This provides greater damping and vibration isolation for Table T from line B1 and the compressor. In addition, both arms 210a and 210b are separately damped from line B2. This provides for a similar vibration-isolating effect. It also conserves space and materials by locating three separate mass dampeners in the same structure, which also facilitates easy transfer and movement of this portion of system 400.

### Modifications of Systems 200, 300, and 400 Not Expressly Shown in FIGS. 2-4

Several additional modifications to systems 200, 300, and 400 are contemplated herein. A brief description follows. It is to be understood that these modifications may be applied to any of the variations described, implied, or suggested by this disclosure.

Additional modifications include adding wheels to the components (e.g., to the components including various masses and/or the component including arms 220a and 220b and the three mass dampeners in system 400). Such wheels would enhance the facility of movement of the entire system. Moreover, they would allow the repositioning of various mass dampeners (masses) as needed, increasing the flexibility of noise dampening in the system. In addition, active noise/vibration cancellation may be added to any of the noise-dampening mechanisms herein (e.g., on Table T, clamps 220a-220d, arms 210a and 210b, and lines B1 and B2).

In addition, isolator padding (e.g., of the same or different type as isolator described above in the context of FIG. 3) or “feet” may be placed at the bottom of any of the components (e.g., vacuum pump, various masses including the component having arms 210a and 210b, the compressor/cryogen reservoir, and Table T, etc.). This can be done to, among other things, further dampen and isolate vibrations.

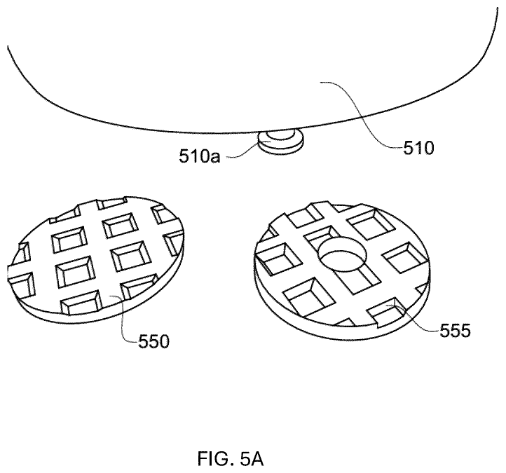

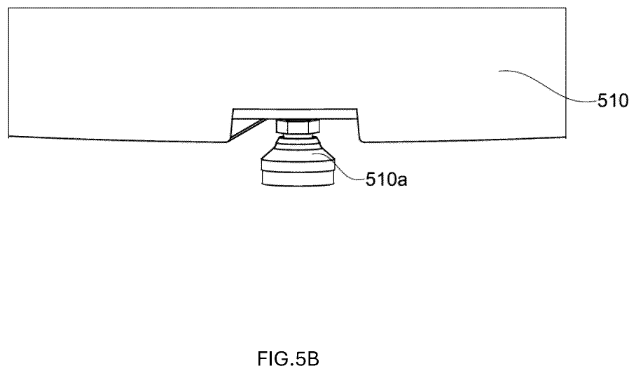

Feet variations are shown in FIGS. 5A and 5B below. Variations contemplated include feet made of steel or other metal (e.g., as shown in FIG. 5B), metal feet with a rubber pad, and metal feet with a pad comprising a spring mass dampener or elastomer system. Variations include feet with rigid/fixed connections or anchors to the ground. Variations include “lag bolts” that allow components a limited degree of lateral movement and vibration dampening. Variations also include various types of adhesive. Variations with no feet are also contemplated.

Active noise dampening may also be added to the active components (e.g., the compressor/cryogen reservoir). This can be done to improve vibration mitigation generally. It can also help improve dampening of the exterior (e.g., building vibrations). The active dampener could be assisted via any number of vibration sensors located throughout variations 200, 300, and 400. In one example, sensors could be placed on lines B1 and B2 to determine the amplitude of their vibrations. In another, a vibration sensor may be added to Table T. In the latter case, the active dampener may be used to reduce a difference in vibrations of the Floor, B1, B2, or other components and Table T.

It is contemplated to extend mass dampening (passive and active, as discussed above) to other features not shown in FIGS. 1-4. For example, laboratory hard piping, braided flex lines, electrical cables, and pneumatic lines (not shown) are all vibration pathways. Each of these components can be independently isolated and mass-damped in much the same way lines B1 and B2 are in FIGS. 2-4.

Variations of Clamps 220a-220d

As discussed briefly above in the context of FIG. 2, vibration mitigation effectiveness can be impacted by the clamp shape, material, and holding force on the transfer line. To maximize interlocking force and interaction with lines B1 and B2, the interior shape of the clamps 220a-220d on the external (ridged, bellowed) shape of lines B1/B2 as shown in FIG. 6A was modeled.

More specifically, clamps were molded to mate with the ridges on the line B1/B2 bellows shown in FIG. 6A. Such molding can interlock portions of the clamp with the ridged portions of the bellows to potentially control (and substantially decrease) vibrational motion in multiple axes/directions. Although clamps holding only to the outer diameter of the line (outer bellows) can effectively dampen transverse vibrations, such clamps were shown to have difficulty damping vibrations perpendicular to the flow of coolant in lines B1/B2. In contrast, clamps molded to conform to or otherwise interlock with the bellows of B1/B2, as described above, can dampen these transverse vibrations.

FIG. 6B is a cross-sectional drawing that illustrates how the molded clamp fits with line B1 bellows. The direction of coolant flow is given in FIG. 6B. The 3D-printed clamp design is shown in FIGS. 6C and 6D. Clamp 220a-220d materials can encompass any suitable, moldable or printable via additive manufacturing materials. These include 3D printable metals and plastics.

### Examples

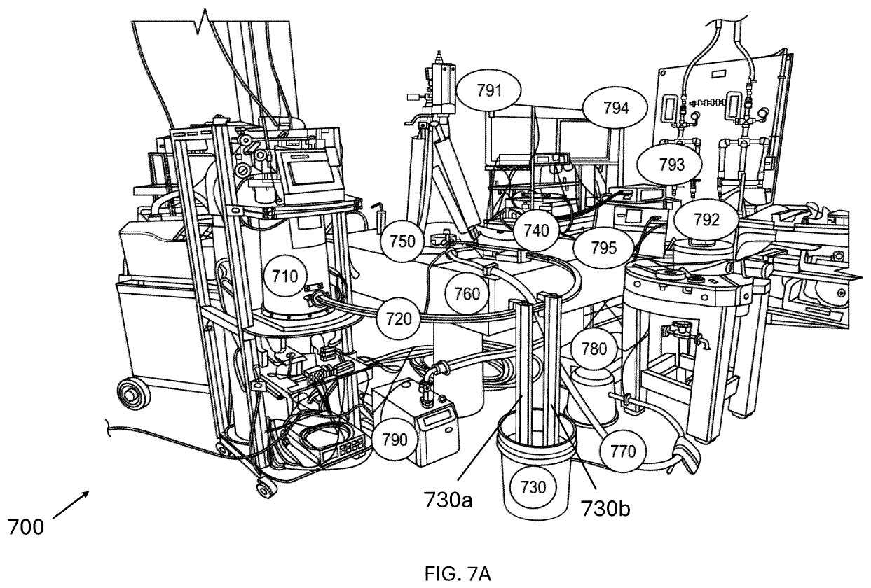

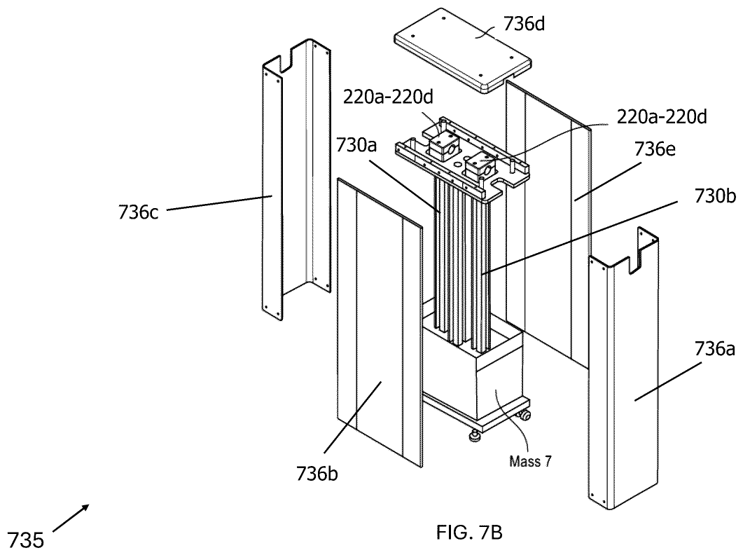

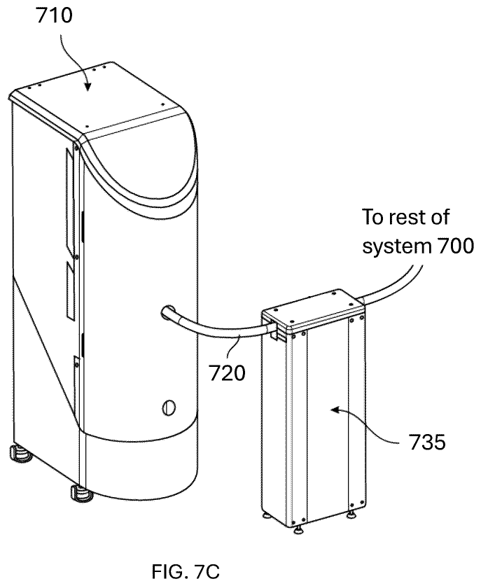

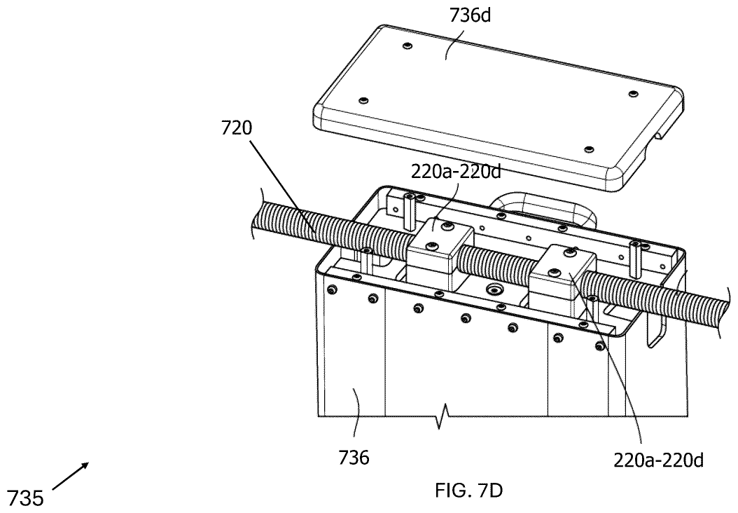

FIG. 7A shows an experimental setup 700 for testing vibration mediating designs disclosed herein. The components shown in FIG. 7A are described below. Here we apply a testing technique designed to measure vibrations having amplitude on the nm scale to show the effectiveness of noise dampening capabilities of system 700.

Cryocooler 710 supplies liquid helium to system 700. In general, such coolers 710 can contribute substantially to vibrational noise. In one example embodiment, cooler 710 is an infinite helium cryocooler made by Lakeshore Cryotronics of Westerville, Ohio. However, it is to be understood that cryocooler 710 can be any suitable cryocooler that can supply any suitable cooling liquid to system 700. For example, any of the Coolant Delivery Systems shown in FIGS. 1-4 may be represented by Cryocooler 710. Transfer line 720 carries liquid coolant from cryocooler 710 through the system 700. As shown in FIG. 7A, transfer line 720 may comprise flexible vacuum hose systems used cryogenic measurements. In particular, it may represent bellow flex lines B1 and B2 shown in FIG. 4. It may comprise stainless steel and or other components described herein.

As shown in FIG. 7A, system 700 may include mass dampener 730. Mass dampener 730 may include any combination of Masses 1-7 shown in FIGS. 1-4, or similar masses. FIG. 7A shows mass dampener 730 as weights configured within a vessel or bucket. This is a common configuration. It may be used to hold several mass dampeners and/or mass isolators such as those discussed above in the context of FIGS. 1-4. The masses may be held in place by any suitable means, including sand or adhesive material. That said, it should be understood that alternative configurations are possible.

For example, FIGS. 7B-7D show an alternative to mass dampener 730 in the form of mass dampener 735. Dampener 735 includes a weight (Mass 7) that may be the same as the weight in dampener 730. It further includes arms 730a and 730b, as well as clamps 220a-220d. The main difference is that dampener 735 also includes housing 736 (including housing components 736a-736e). Housing 736 may serve to shield the interior components of dampener 735 from dust and/or contamination. Housing 736 may also have a noise dampening effect. It is to be understood that housing 736 may be applied to any of the variations described herein. Moreover, it is to be further understood that the design, shape, and form of housing 736 shown in FIGS. 7B-7D is merely exemplary. Modifications of this design, as well as other housing designs, are possible and within the scope of the present disclosure.

Turning back to FIG. 7A, the figure also shows various other aspects of system 700 including table clamp 740. Table clamp 740 is similar to the cable clamps discussed above, most notably table clamp 220c of FIG. 2 (shown in the figure as clamping flex line B1 to the table). FIG. 700 shows table clamp 760 next to the cryostat 750 for mounting to table 795. It also shows return line 770, which is part of the B1/B2 line. In addition it has a return mass dampener 780 similar to the mass described above (i.e., Mass 1-7). FIG. 7A also shows circulation pump 790. Pump 790 circulates coolant fluid in the system 700 through the transfer line 720. Circulation pump 790 can be, for example, any of the pumps shown in FIGS. 1-4 including the “vacuum pump.”

### Data Acquisition

As shown in FIG. 7A, vibrations were measured using a laser vibrometer setup including laser vibrometer 791 and vibrometer controller 792. Vibrometer 791 was a Polytec Vibrometer. Cryostat 750 was a Lake Shore ST-500 series microscopy cryostat. During data acquisition, cryostat 750 was mounted on floating optical table 795. Cryocooler 710 was mounted on top of a rolling table. Vibration amplitude measurements from vibrometer 791 were collected and analyzed by a Lake Shore M81 Synchronous Source Measure System 793 in communication with computer 794. However, it is to be understood that other measurement systems and components known in the art may be used to acquire similar data under similar conditions.

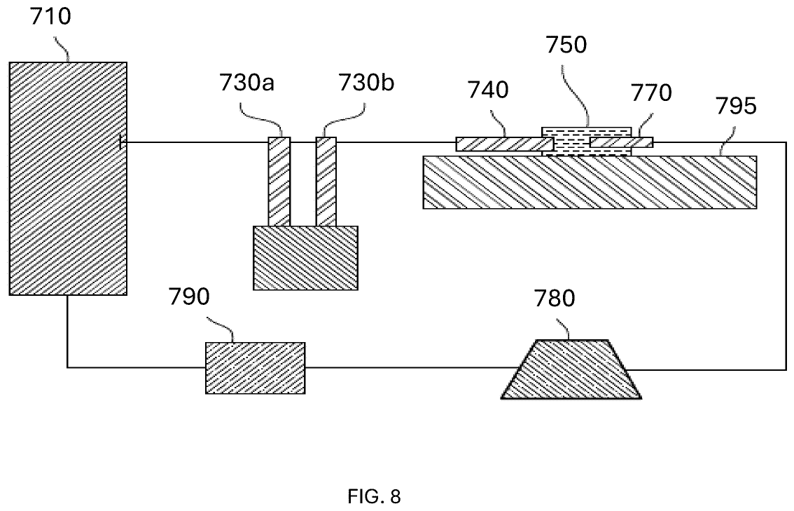

FIG. 8 is a schematic showing the essential components of setup 700 for data acquisition. The two major vibration sources are the cryocooler 710 and the return pump 790. Vibration data was acquired with vibrometer 791 set to a gain of 0.5 μm/V. The data streaming rate was 1000 Hz with 0.06 power line cycles (NPLC) for 120 seconds.

### Data Processing

The vibration data was processed as follows. The data was broken into 24 segments of five second duration. Fast Fourier Transform (FFT) analysis was then performed on each data segment. A Hanning window was used to average and smooth the data. More specifically, the Hanning window averaged all 24 FFTs together to reduce the noise. This analysis produced noise density (m/√Hz) vs frequency with a bandwidth of 0.2 Hz. This noise density is independent of bandwidth. This is in contrast with other measurable quantities (e.g., amplitude (m)) that are bandwidth dependent.

Vibration root mean square (RMS) amplitude was calculated as follows. The RMS amplitude was taken as the square root of the integral of the squared noise density vs frequency. The integral was evaluated from high to low frequency, specifically from 500 Hz down to a particular lower frequency f. Integrating from high to low frequency can decrease the contribution of drift.

### Results

System 700 was used to measure the vibration RMS amplitude at the location of each of the components shown in FIG. 8. In particular, RMS was measured for the components likely to be the source of most, if not all, of the significant vibrations. These components are cryocooler 710 and pump 790. Such measurements established vibration baselines. Propagation of vibrations made by these components through system 700 was measured at seven other locations. These were the locations of the following components: arm 730a, arm 730b, transfer line 720, cryostat 750, table 795, return line 770, return mass dampener 780, and circulation pump 790. These measurements, taken together, give an overview of how vibrations travel within system 700.

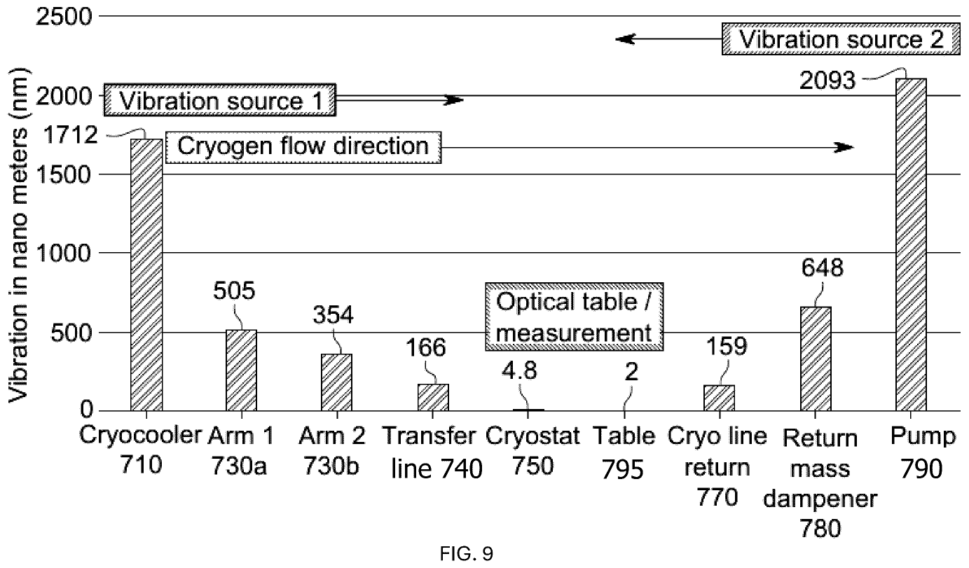

FIG. 9 shows the results of the vibration RMS measurement by component. The individual numerical results are shown below in Table 1 in terms of vibration in the lateral (x) direction.

TABLE 1
Measured RMS Vibrational Amplitude in Setup 700 by Component

| | | Measured Vibrational |
|---|---|---|
| Element | Name | RMS (nm) |
| 710 | Cryocooler | 1712 |
| 730a | Arm 1 | 505 |
| 730b | Arm 2 | 354 |
| 740 | Transfer Line | 166 |
| 750 | Cryostat | 4.8 |
| 795 | Table | 2 |
| 770 | Cryo Line Return | 159 |
| 780 | Return Mass Dampener | 648 |
| 790 | Pump | 2093 |

In particular, FIG. 9 confirms the highest measured vibration amplitudes, 1712 nm and 2093 nm vibration RMS, are measured at the locations of cooler 710 and pump 790, respectively. FIG. 9 further shows how vibration amplitude decreases systematically as one travels along the cooling lines from either end (i.e., from the cooler 710 end or from the pump 790 end) to the interior of system 700. This is likely why the lowest vibration amplitudes (4.5 nm and 2 nm) are measured at and near the relatively central location of the cryostat 750. This low measured vibration amplitude at the cryostat 750 likely results from its relatively central location and the collective work of the noise/vibration dampening mechanisms of system 700 discussed above. The decrease in relative RMS amplitude as the vibration dampening mechanisms are changed (as described above) provides a measure of the effectiveness of vibration dampening.

FIG. 9 shows that arms 730a and 730b, significantly dampen vibrations as they travel through the system. For example, the vibration amplitude produced by cryocooler 710 has already decreased by 90% when measured at transfer line 720. This is after the vibrations have passed through arms 730a and 730b and been mitigated by their mass dampening effects, as described above. However, it is before the vibrations have been dampened by pneumatic table 795. In fact, the vibration amplitude is essentially zero to within experimental error when measured on experimental table 795 (e.g., vibrations measured at cryostat 750 mounted on table 795 or on table 795 itself). This represents more than a 99% decrease in amplitude of vibrations as they travel from cryocooler 710, through the noise dampening mechanisms, to sample 5 in cryostat 750.

FIG. 9 shows a similar result with respect to vibrations created by pump 790. More specifically, the measured RMS vibration amplitude at the pump 790 vibration source (i.e., 2093 nm) decreases by 92% before it reaches the cryo line return 770. This shows the noise dampening effect of return mass dampener 780. As pointed out above, any vibrations from pump 790 have been essentially dampened to zero amplitude to within experimental error before they reach cryostat 750. Together these results support the conclusions that the mass dampening setup in system 700 (e.g., mass dampening through arms 730a and 730b as well as dampener 780) can decrease more than 90% of the amplitude of the nm-scale vibrations prior to pneumatic mitigation by table 795.

### Variations in Noise Dampening Setup

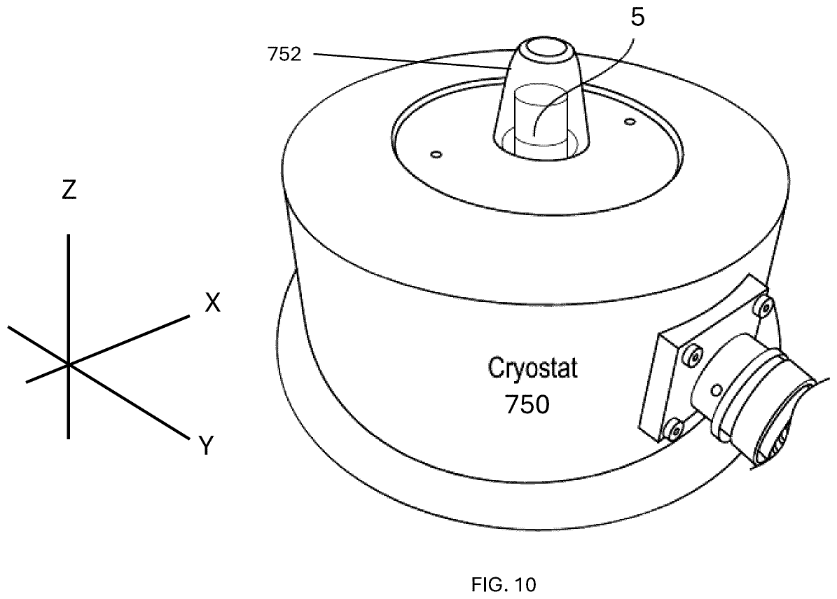

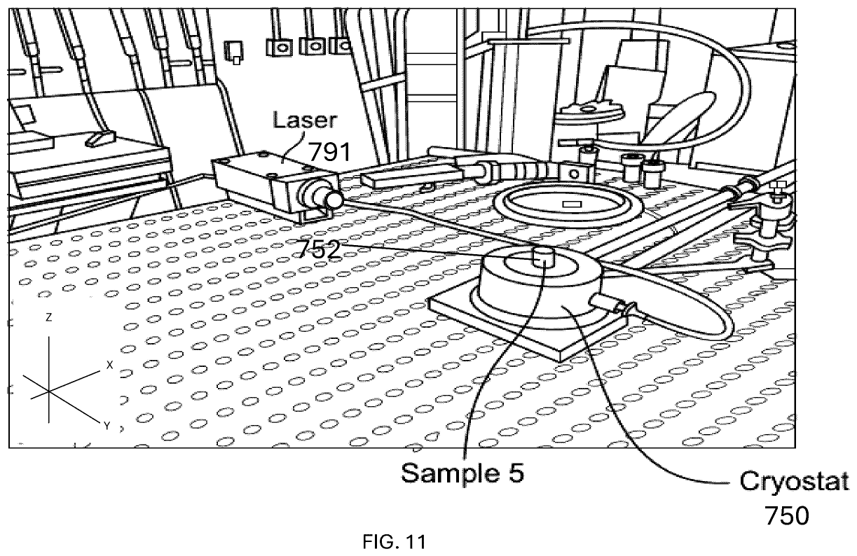

In addition to the above-described setup, several alterations of system 700 were independently tested for vibration dampening. Table 2 below summarizes the results. We note here that a variation in the setup shown in FIG. 7A was used to test vibrational amplitude in both x and y directions as defined with respect to cryostat 750 in FIG. 10. As shown in FIG. 10, the cryostat 750 includes a window 752 that allows laser light to illuminate sample 5. Window 752 also allows reflected laser light to be collected in x, y, and z directions. FIG. 11 shows the laser 791 position in the actual experimental setup. Measurements of z-direction vibrations are also possible with modifications to the setup shown in FIG. 11.

TABLE 2
Effect of multiple arms 730 on mass dampening
applied between cryocooler 710 and cryostat 750

| | Measured Vibrational |
|---|---|
| Setup Components | RMS (nm) |
| One arm (730a) only | 8.485 |
| Two arms (730a and 730b) | 4.822 |

As shown in Table 2, one test varied the number of arms 730a and 730b in the dampening system between cryocooler 710 and cryostat 750. It was found that adding a second arm to the dampening, as shown in FIG. 7A, had a significant effect on vibration dampening. In fact adding a second arm without adding additional weight decreased the noise amplitude by around 43%.

Having established that adding more than one arm (730) to the mass dampening system of the cryocooler 710 substantially decreases vibrations, a number of two arm variations were tested. These changed other aspects, such as the feet 510a. The results of the most consequential variations are shown below in Table 3.

TABLE 3
Effect of varying feet 510a on noise dampening

| | Measured Vibrational |
|---|---|
| Variation | RMS (nm) |
| Feet 510a omitted from system 700 | 15.001 |
| Metal feet 510a only | 4.926 |
| Metal feet 510a on a rubber mat | 7.783 |
| Metal Feet 510a, each with a rubber pad | 4.130 |
| Conically shaped metal feet 510a | 6.165 |
| Floor-anchored, conically shaped metal feet 510a | 5.440 |

As shown in Table 3, the composition of metal feet in system 700 (e.g., foot 510a on cryocooler 510 shown in FIG. 5B) had an impact on vibration amplitude of hundreds of percent. Metal feet 510a were found to be generally effective noise dampeners. Including feet of some kind was far better than having no feet at all. Table 3 also shows that noise dampening effectiveness of the metal feet generally does not improve when those feet were placed on rubber matting material. Results also show that certain variations in the shape of the feet seem to make a lesser contribution to noise mitigation. However, they also show substantially increased noise dampening when rubber pads are included.

Also tested was how the surface of the laboratory floor contacted by the feet (e.g., feet 510a), referred to herein as the “feet landing surface,” affects noise dampening. The alternative surfaces to bare metal/floor contact included 1) “A tape” (also known as nano tape or gecko tape, is a double-sided, commercially available and reusable tape that can stick to many surfaces without the use of screws or anchors), 2) thin red” tape (another commercially available double-sided, pressure-sensitive adhesive tape), and 3) VHB “Foam” tape (a commercially available tape in the form of a white foam).

TABLE 4
Effect on noise dampening of varying the feet landing surface

| | Measured Vibrational |
|---|---|
| Variation | RMS (nm) |
| Bare floor (metal feet 510a touching bare floor) | 4.822 |
| Metal feet 510a touching A tape | 4.679 |
| Metal feet 510a touching thin red tape | 4.321 |
| Metal feet 510a touching foam tape | 4.015 |

The results in Table 4 suggest that the surface contacted by feet 510a does, in fact, have an impact on vibration damping. In particular, the foam tape seemed to perform best as the contact surface. That said, each of the three types of tape (A, thin red, and foam) offer some form of vibration damping improvement over bare metal.

The effect on vibration damping of other variables in system 700 was also explored. For example, clamping torque was varied from 6-36 in-lbs. The weight of the bucket holding mass dampening arms 730a and 730b was also varied from 60-136 pounds. Surprisingly, the variables showing the most impact on noise dampening were the number of mass damping arms (Table 2), the feet composition (Table 3), and the feet landing surface (Table 4).

While various inventive aspects, concepts, and features of the inventions have been described and illustrated herein as embodied in certain exemplary embodiments, these various aspects, concepts, and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include both the specified value and values within 10% of the specified value, unless expressly stated otherwise. Further, it is to be understood that the drawings accompanying the present application may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

We claim:

1. A cooling system comprising:
a conduit configured to carry a cryogenic fluid to a cooling target;
a support supporting the conduit, wherein the support comprises:
a first clamp for clamping the conduit in place; and
a first weight for dampening vibrations in the conduit,
wherein the support dampens nm-scale vibrations.

2. The cooling system of claim 1, wherein the system is configured to decrease an amplitude of nm-scale vibrations induced by a coolant supply by greater than 90% before reaching a sample.

3. The cooling system of claim 2, wherein the system is configured to decrease the amplitude of nm-scale vibrations induced by the coolant supply by greater than 99% before reaching the sample.

4. The cooling system of claim 1, wherein the system is configured to decrease an amplitude of nm-scale vibrations induced by a pump by greater than 80% before reaching a sample.

5. The cooling system of claim 4, wherein the system is configured to decrease the amplitude of nm-scale vibrations induced by the pump by greater than 92% before reaching the sample.

6. The cooling system of claim 1, wherein the support further comprises:
a second clamp for clamping the conduit in place; and
a second weight for dampening vibrations in the conduit.

7. The cooling system of claim 6, wherein the first weight is vibrationally isolated from the second weight.

8. The cooling system of claim 1, wherein the first weight is vibrationally isolated from a floor on which the cooling system rests.

9. The cooling system of claim 1, wherein the first weight is vibrationally connected to a floor on which the cooling system rests.

10. The cooling system of claim 6, wherein the second weight is vibrationally isolated from a floor on which the cooling system rests.

11. The cooling system of claim 1, further comprising a sub-system for recycling the cryogenic fluid.

12. The cooling system of claim 11, wherein the sub-system comprises a vacuum pump and a line to the vacuum pump.

13. The cooling system of claim 12, wherein the line to the vacuum pump is coupled to a mass to dampen vibrations.

14. The cooling system of claim 13, wherein the mass is vibrationally de-coupled from the first weight.

15. The cooling system of claim 14, wherein the mass is vibrationally de-coupled from any other weights in the cooling system.

16. The cooling system of claim 1, wherein the first clamp is 3D printed.

17. A measurement system comprising the cooling system of claim 1.

18. The measurement system of claim 17 comprising an analytical device for performing at least one of Energy Dispersive X-ray Spectroscopy (EDS or EDX), X-ray Fluorescence Spectroscopy (XRF), X-ray Photoelectron Spectroscopy (XPS or ESCA), Extended X-ray Absorption Fine Structure (EXAFS), X-ray Absorption Near Edge Structure (XANES), X-ray Emission Spectroscopy (XES), and X-ray Diffraction (XRD).

19. The measurement system of claim 17 comprising an analytical device for performing at least one of Auger Electron Spectroscopy (AES), Photoemission Spectroscopy (PES), Inverse Photoelectron Spectroscopy (IPES), Angle-Resolved Photoemission Spectroscopy (ARPES), X-ray Photoelectron Spectroscopy (XPS or ESCA), Electron Energy Loss Spectroscopy (EELS), and Cathodoluminescence Spectroscopy (CL).

20. A method of cooling a sample for testing using a cooling system, the method comprising:
supplying a cryogenic fluid to a cooling target via a conduit;
dampening nm-scale vibration in the cooling system via a support supporting the conduit, the support comprising:
a clamp for clamping the conduit in place; and
a weight for dampening vibrations in the conduit.
